(19) United States
(12) Patent Application Publication
(10) Pub. No.: US 2019/0243461 A1
(43) Pub. Date: Aug. 8, 2019

(54) CABLE MOVABLE REGION DISPLAY DEVICE, CABLE MOVABLE REGION DISPLAY METHOD, AND CABLE MOVABLE REGION DISPLAY PROGRAM

(71) Applicant: MITSUBISHI ELECTRIC CORPORATION, Tokyo (JP)

(72) Inventor: Kento YAMAZAKI, Tokyo (JP)

(73) Assignee: MITSUBISHI ELECTRIC CORPORATION, Tokyo (JP)

(21) Appl. No.: 16/315,971

(22) PCT Filed: Jul. 26, 2016
(86) PCT No.: PCT/JP2016/071824

§ 371 Date: Jan. 7, 2019

(51) Int. Cl. G06F 3/01; G06F 17/50; H02G 1/06; G06T 19/00

(52) U.S. Cl. CPC G06F 3/017; G06F 17/5009; G06T 19/003; H02G 1/06; G06F 3/011

(57) ABSTRACT

A cable movable region display device includes a real space information acquisition unit that acquires real space information regarding a real space, a user position posture estimation unit that determines a position and posture of a user based on the real space information, a simulation unit that receives wiring path information indicating a starting end, a passage point and a terminal end of the wiring path and cable information indicating a permissible bending radius of the cable and a length of the cable and calculates the cable movable region based on the wiring path information and the cable information, an image generation unit that generates a cable movable region image of virtual reality indicating the cable movable region in the real space based on the cable movable region calculated by the simulation unit and the position and posture determined by the user position posture estimation unit, and an image display unit that displays the cable movable region image of virtual reality.

### TECHNICAL FIELD

The present invention relates to a cable movable region display device, a cable movable region display method and a cable movable region display program for displaying a cable movable region while superimposing the cable movable region on a real space.

### BACKGROUND ART

There has been proposed a technology employing AR (Augmented Reality), which generates CG (Computer Graphics) as an additional information image based on the position and posture of a user estimated from real space information (e.g., image data or distance information regarding a distance to a subject) acquired by a camera (image capturing device), a sensor (e.g., depth sensor) or the like, and draws the generated CG while superimposing the CG on a real space as if the generated CG actually existed in the real space. There has also been proposed a technology which determines the position and posture of a camera in an arbitrary three-dimensional coordinate system based on two-dimensional image data acquired by the camera, generates CG in the three-dimensional coordinate system on a computer based on the determined position and posture of the camera, and draws the generated CG while superimposing the CG on a real space. In a case where these technologies are employed for a work support system in work carried out by a user (worker), the worker can see the situation as if objects displayed by the CG actually existed in the real space, and thus the worker can receive intuitively and easily understandable work instructions.

For example, Patent Reference 1 proposes an information display device that generates image information on which drawing information emphasizing a pertinent equipment part in captured image information in regard to a plant has been superimposed, and displays the generated image information on a display unit.

### PRIOR ART REFERENCE

### Patent Reference

Patent Reference 1: Japanese Patent Application Publication NO. 2013-117812 (Abstract, Paragraph 0009, FIG. 2)

### SUMMARY OF THE INVENTION

### Problem to be Solved by the Invention

In general, a wiring path of a cable in cable wiring work is determined based on characteristics of a cable to be used, a wiring path, and its surrounding circumstance (e.g., a position of an obstacle or the like), in which a certain degree of deviation within a permissible range is allowed. However, the above-described conventional device has a problem in that the device, which displays an ideal wiring path of a cable, is incapable of displaying the permissible range of the wiring path of the cable (hereinafter also referred to as a “cable movable region”) while superimposing the cable movable region on the real space.

The present invention has been made to resolve the above-described problem, and its object is to provide a cable movable region display device, a cable movable region display method and a cable movable region display program that make it possible to display a cable movable region in cable wiring work while superimposing the cable movable region on a real space.

### Means for Solving the Problem

A cable movable region display device according to an aspect of the present invention is a device for displaying a cable movable region representing a permissible range of a wiring path of a cable while superimposing the cable movable region on a real space, the cable movable region display device including: a real space information acquisition unit to acquire real space information regarding the real space; a user position posture estimation unit to determine a position and posture of a user based on the real space information; a simulation unit to receive wiring path information indicating a starting end, a passage point and a terminal end of the wiring path and cable information indicating a permissible bending radius of the cable and a length of the cable and to calculate the cable movable region based on the wiring path information and the cable information; an image generation unit to generate a cable movable region image of virtual reality indicating the cable movable region in the real space based on the cable movable region calculated by the simulation unit and the position and posture determined by the user position posture estimation unit; and an image display unit to display the cable movable region image of virtual reality.

A cable movable region display method according to another aspect of the present invention is a cable movable region display method for making an image display unit display a cable movable region representing a permissible range of a wiring path of a cable while making the image display unit superimpose the cable movable region on a real space, the cable movable region display method including: a real space information acquisition step of acquiring real space information regarding the real space; a user position posture estimation step of determining a position and posture of a user based on the real space information; a simulation step of acquiring wiring path information indicating a starting end, a passage point and a terminal end of the wiring path and cable information indicating a permissible bending radius of the cable and a length of the cable and calculating the cable movable region based on the wiring path information and the cable information; an image generation step of generating a cable movable region image of virtual reality indicating the cable movable region in the real space based on the cable movable region calculated in the simulation step and the position and posture determined in the user position posture estimation step; and a display step of making the image display unit display the cable movable region image of virtual reality.

A cable movable region display program according to another aspect of the present invention is a program for making a computer, which makes an image display unit display a cable movable region representing a permissible range of a wiring path of a cable while making the image display unit superimpose the cable movable region on a real space, perform: a real space information acquisition process of acquiring real space information regarding the real space; a user position posture estimation process of determining a position and posture of a user based on the real space information; a simulation process of acquiring wiring path information indicating a starting end, a passage point and a terminal end of the wiring path and cable information indicating a permissible bending radius of the cable and a length of the cable and calculating the cable movable region based on the wiring path information and the cable information; an image generation process of generating a cable movable region image of virtual reality indicating the cable movable region in the real space based on the cable movable region calculated in the simulation process and the position and posture determined in the user position posture estimation process; and a display process of making the image display unit display the cable movable region image of virtual reality.

### Effect of the Invention

According to the present invention, the cable movable region of a cable to be wired can be displayed so as to be superimposed on a real space.

### BRIEF DESCRIPTION OF THE DRAWINGS

FIG. 1 is a diagram showing a configuration and functions of a cable movable region display device according to a first embodiment of the present invention.

FIG. 2 is a hardware configuration diagram showing the cable movable region display device according to the first embodiment.

FIG. 3 is a flowchart showing an example of an information display process in the cable movable region display device according to the first embodiment.

FIG. 4 is a flowchart showing an example of a process of simulating the cable movable region in the cable movable region display device according to the first embodiment.

FIG. 5 is a diagram showing a method of determining a cable movable region in consideration of the length of a cable.

FIG. 6 is a diagram showing a permissible bending radius of a cable.

FIG. 7 is a diagram showing a configuration and functions of a cable movable region display device according to a second embodiment of the present invention.

FIG. 8 is a flowchart showing an example of a process of detecting a position of a hand in the cable movable region display device according to the second embodiment.

FIG. 9 is a flowchart showing an example of a process of simulating the cable movable region in the cable movable region display device according to the second embodiment.

FIG. 10 is a diagram showing a configuration and functions of a cable movable region display device according to a third embodiment of the present invention.

FIG. 11 is a flowchart showing an example of a process of limiting a cable movable region in the cable movable region display device according to the third embodiment.

FIG. 12 is a diagram showing a configuration and functions of a cable movable region display device according to a fourth embodiment of the present invention.

FIG. 13 is a diagram showing a display example of the cable movable region displayed by the cable movable region display device according to the fourth embodiment.

### MODE FOR CARRYING OUT THE INVENTION

### (1) First Embodiment

### (1-1) Configuration

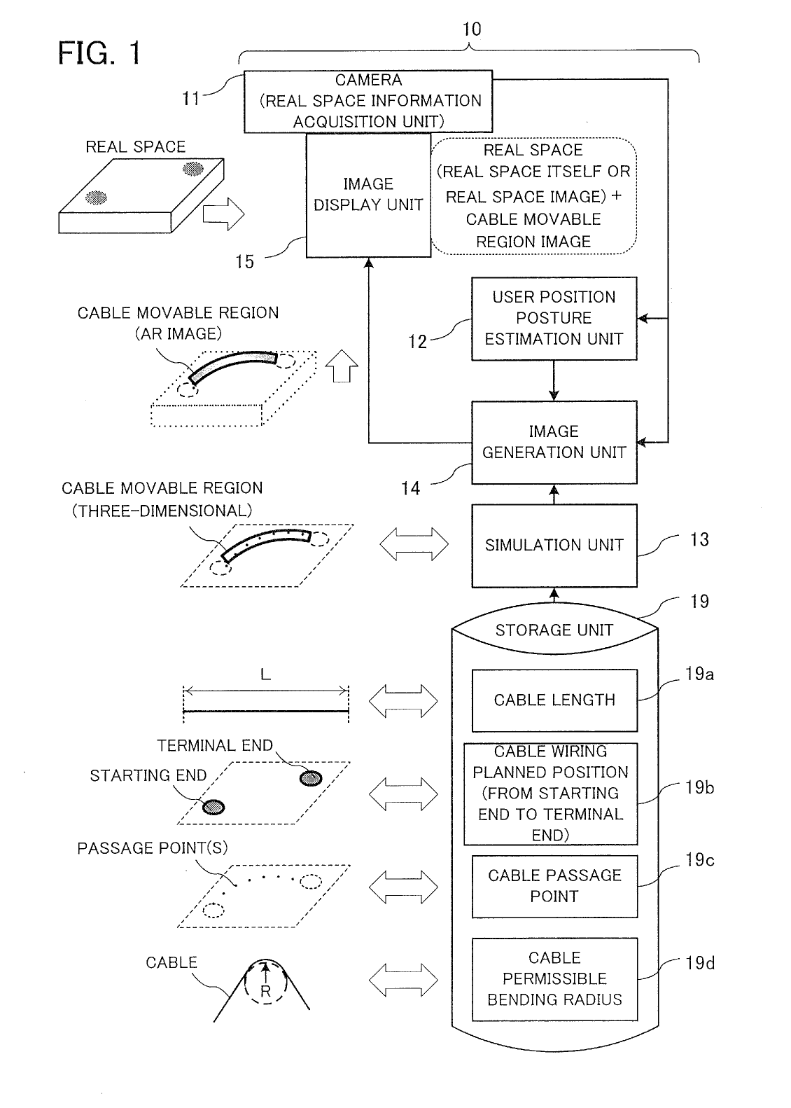

FIG. 1 is a diagram showing a configuration and functions of a cable movable region display device 10 according to a first embodiment of the present invention. The cable movable region display device 10 is an information display device capable of displaying a cable movable region that represents a permissible range of a wiring path of a cable (cord-like object) while superimposing the cable movable region on a real space in front of a user (worker). Further, the cable movable region display device 10 is a device capable of executing a cable movable region display method according to the first embodiment.

As shown in FIG. 1, the cable movable region display device 10 includes a real space information acquisition unit (camera, sensor) 11, a user position posture estimation unit 12, a simulation unit 13, an image generation unit 14, and an image display unit (display device) 15. The cable movable region display device 10 may include a storage unit 19 for storing information on the cable such as a cable length (L) 19a and a cable permissible bending radius (R) 19d (cable information) and information on the wiring path of the cable such as a cable wiring planned position (a starting end and a terminal end) 19b and cable passage points 19c (wiring path information).

The cable movable region display device 10 is, for example, a wearable computer worn by the user on his body. The cable movable region display device 10 may also be a PC (Personal Computer) such as a desktop PC or a notebook PC. In such cases, a camera worn by the user on his head can be used as the real space information acquisition unit 11, for example, and a see-through display provided in front of the eyes of the user (head-mounted display having a structure of the head-mounted type to be mounted on the head of the user) can be used as the image display unit 15, for example. In the case of using the see-through display, the user sees an additional information image displayed on the see-through display while seeing the real space through the see-through display. However, the image generation unit 14 can also display a real space on the image display unit 15 based on image information acquired by the real space information acquisition unit 11 while displaying the additional information image on the image display unit 15 in a superimposing manner.

The cable movable region display device 10 can also be, for example, a mobile information terminal such as a tablet terminal or a smartphone. In this case, a camera built in the mobile information terminal can be used as the real space information acquisition unit 11, and a display panel of the mobile information terminal can be used as the image display unit 15. However, even in such cases, a camera worn by the user on his head can be used as the real space information acquisition unit 11, for example, and a see-through display provided in front of the eyes of the user can be used as the image display unit 15, for example.

The real space information acquisition unit 11 acquires real space information regarding the real space. The real space information acquisition unit 11 is, for example, a camera for generating image data corresponding to the real space by capturing an image of the real space. The real space information acquisition unit 11 may include a sensor for acquiring information corresponding to the real space (e.g., depth sensor for acquiring distance information regarding a distance to a subject) instead of or in addition to the camera.

The image display unit 15 is an information display unit such as a display or a projector which displays CG of the cable movable region as a virtual reality (AR) image. The image display unit 15 may be, for example, a see-through display having a transparent or semitransparent screen. The user can see the AR image displayed on the screen as the additional information image (CG of the cable movable region) so as to be superimposed on the real space, while seeing the real space through the see-through display. In a case where the image display unit 15 is a projector, the projector can also directly project the AR image onto the real space through no screen. For example, the projector as the image display unit 15 may display (project) a projection image as the AR image (image indicating the cable movable region) on an actually existing floor, wall, cable tray, equipment (device) or the like. Incidentally, the real space information acquisition unit 11 and the image display unit 15 may be provided as either an integrated device or separate devices connected to each other by a connection cable.

The user position posture estimation unit 12 performs a process of determining the position and posture of the user in an arbitrary three-dimensional coordinate system based on the real space information (e.g., image data or distance data regarding the distance to the subject) acquired by the real space information acquisition unit 11 (i.e., performs a user position posture estimation process).

The storage unit 19 stores the cable information such as the cable length (L) 19a and the cable permissible bending radius (R) 19d and the cable wiring path information such as the cable wiring planned positions (the starting end and the terminal end) 19b and the cable passage point 19c. While, in FIG. 1, the storage unit 19 is a part of the cable movable region display device 10, the cable information and the cable wiring path information may also be provided from an external device outside the cable movable region display device 10. In this case, the cable movable region display device 10 does not have to include the storage unit 19.

The simulation unit 13 receives the wiring path information indicating the cable wiring planned positions (the starting end and the terminal end) 19b and the cable passage point 19c situated between the starting end and the terminal end and the cable information indicating the cable permissible bending radius (R) 19d and the cable length (L) 19a from the storage unit 19 and calculates (simulates) three-dimensional image data of the cable movable region from the wiring path information and the cable information.

The image generation unit 14 generates a cable movable region image (two-dimensional image), as an AR image indicating the cable movable region in the real space, based on the cable movable region (three-dimensional image) calculated by the simulation unit 13 and the position and posture of the user determined by the user position posture estimation unit 12. In other words, the image generation unit 14 generates three-dimensional CG in a three-dimensional coordinate system in the computer based on the cable movable region calculated by the simulation unit 13 and generates the AR image to be drawn (displayed) while it is superimposed on the real space, based on the real space information acquisition unit 11. The AR image generated in this case is generated to be suitable for the image display unit (characteristics of the display).

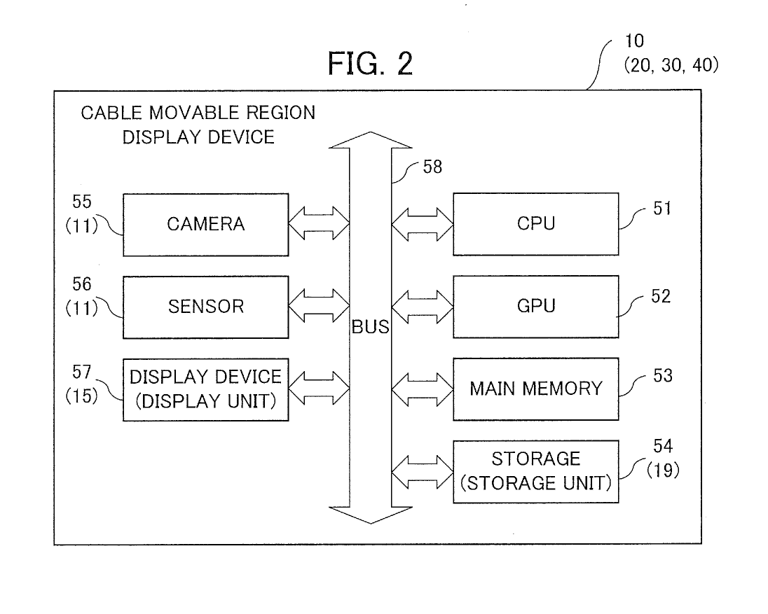

FIG. 2 is a hardware configuration diagram showing the cable movable region display device 10 according to the first embodiment. However, the hardware configuration of the cable movable region display device 10 is not limited to an example shown in FIG. 2 and various modifications are possible. Incidentally, reference characters 20, 30 and 40 in FIG. 2 will be referred to in second to fourth embodiments which will be described later.

The cable movable region display device 10 is a computer, for example. The cable movable region display device 10 includes a CPU (Central Processing Unit) 51, a GPU (Graphics Processing Unit) 52, a main memory 53, a storage 54 (i.e., the storage unit 19), and a bus 58. Further, the cable movable region display device 10 includes a camera 55, a sensor 56 and a display device 57 (i.e., the image display unit 15). The camera 55 and the sensor 56 are examples of the real space information acquisition unit 11.

The bus 58 is a data transmission line used by hardware components of the cable movable region display device 10 used for exchanging data. The CPU 51 is an arithmetic device of the cable movable region display device 10 for executing various processes (e.g., information display process). The GPU 52 is an arithmetic device for executing a process regarding generation or drawing of pictures.

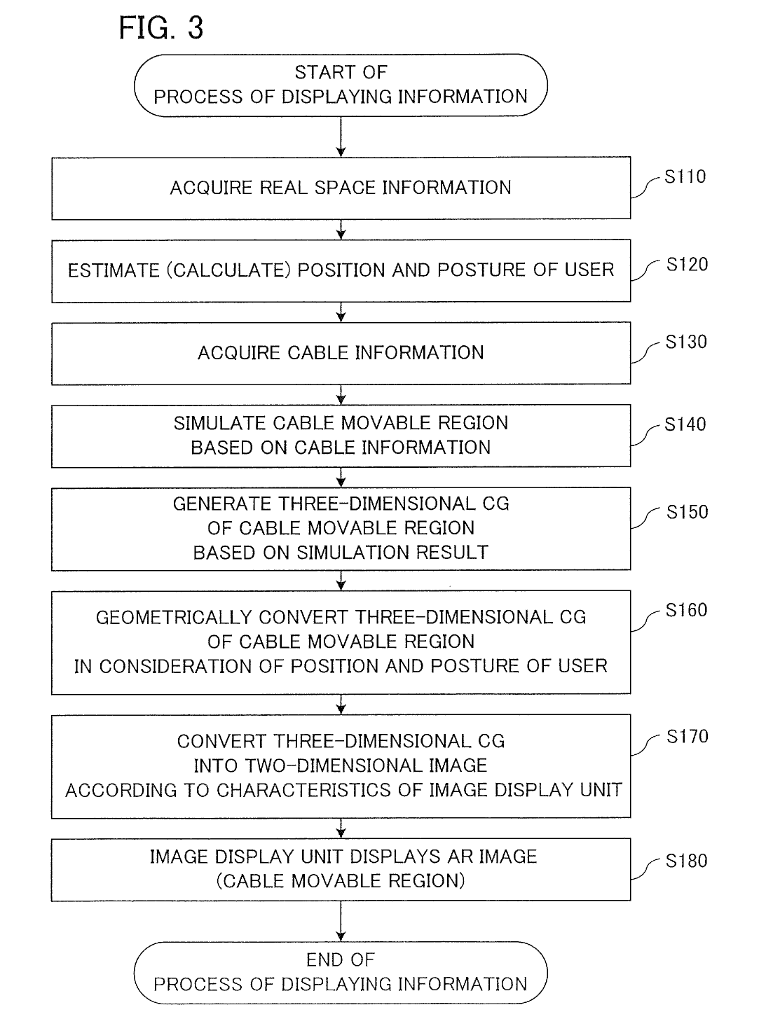

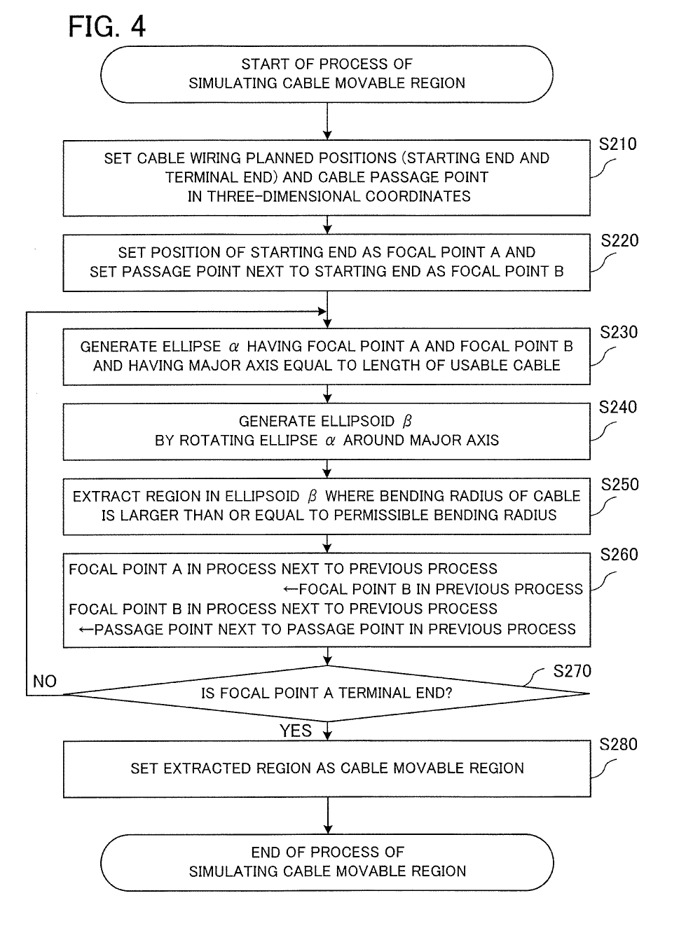

The main memory 53 is a storage device in which erasure and rewriting of data are possible (e.g., semiconductor storage device or the like). Although the main memory 53 is a volatile memory, the main memory 53 has higher writing speed and reading speed than those of the storage 54. Thus, the main memory 53 is used for storing data being used or data to be used immediately. For example, a program for performing the processes shown in FIG. 3 and FIG. 4 is stored in the main memory 53 when the program is executed. The program stored in the main memory 53 is executed by the CPU 51.

The storage 54 is a storage device in which erasure and rewriting of data are possible (e.g., hard disk drive, semiconductor storage device or the like). The storage 54 can be used for storing the data of the storage unit 19. Information stored in the storage 54 is expanded in the main memory 53 when a program is executed.

The camera 55 is a device for capturing an image necessary for acquiring information on the real space. The sensor 56 is a device for acquiring a value necessary for acquiring information on the real space. The sensor 56 is, for example, the GPS (Global Positioning System) for measuring a position, an acceleration sensor for measuring acceleration, a geomagnetism sensor for measuring orientation, or a depth sensor for measuring the distance to the subject.

The display device 57 is the image display unit 15 for displaying the AR image of the cable movable region. The display device 57 is a display of a tablet terminal or a smartphone, for example. The display device 57 can also be a head-mounted display, a monitor of a computer, a projector, or a head-up display.

### (1-2) Operation

FIG. 3 is a flowchart showing an example of the information display process in the cable movable region display device 10 according to the first embodiment. However, the information display process in the cable movable region display device 10 is not limited to the process shown in FIG. 3 and modifications are possible. Incidentally, the information display process shown in FIG. 3 is executed each time the information on the real space is acquired by the camera or the sensor used for the real space information acquisition unit 11 of the cable movable region display device 10.

In step S110, the real space information acquisition unit 11 acquires the real space information. In a case where the real space information acquisition unit 11 is a camera, the real space information is a captured image (image data). In a case where the real space information acquisition unit 11 is a sensor for detecting real space information, the real space information is a detection value of the sensor.

In the next step S120, the user position posture estimation unit 12 calculates (estimates) the position and posture of the user based on the real space information acquired in step S110. The position and posture of the user in this step are expressed with reference to an arbitrary three-dimensional coordinate system determined by the cable movable region display device 10.

In the next step S130, the simulation unit 13 acquires the cable length 19a, the cable wiring planned positions (the starting end and the terminal end) 19b, the cable passage point 19c and the cable permissible bending radius 19d from the storage unit 19.

In the next step S140, the simulation unit 13 calculates (simulates) the cable movable region based on the cable information and the wiring path information acquired in step S130. An example of a method of the simulation is shown in FIG. 4 which will be explained later.

In the next step S150, the image generation unit 14 generates three-dimensional CG based on the cable movable region as the simulation result obtained in step S140. In the next step S160, the image generation unit 14 geometrically converts the three-dimensional CG generated in step S150 in consideration of the position and posture of the user and arranges the converted three-dimensional CG in the arbitrary three-dimensional coordinate system determined by the cable movable region display device 10.

In the next step S170, the image generation unit 14 converts the three-dimensional CG arranged in the three-dimensional coordinate system in step S160 into a two-dimensional image according to the characteristics of the image display unit 15 (display device 57). The method of the conversion from the three-dimensional CG into the two-dimensional image in a case where the real space information acquisition unit 11 is a camera will be explained below. In a case where the three-dimensional CG is combined with an image captured by a camera in a tablet or the like, the conversion can be carried out by using an intrinsic parameter of the camera (e.g., focal length of the camera). In a case where the image display unit 15 is a see-through display (see-through head-mounted display), since an optical axis of the camera and an optical axis of the eyes differ from each other, t translation and rotation processes are performed on the three-dimensional CG to make the two optical axes coincide with each other, and thereafter the conversion process is carried out by using an intrinsic parameter of the eyes (e.g., focal length) similarly to the case of the camera. In a case where the image display unit 15 is a device that projects AR image light onto the real space such as a projector, the conversion process is carried out by employing a method in which back projection by using an intrinsic parameter of the projector is performed on an image obtained by conversion in a computer by using an intrinsic parameter of the camera.

In the next step S180, the image display unit 15 displays the AR image obtained by the conversion process in step S170.

FIG. 4 is a flowchart showing an example of the process of simulating the cable movable region based on the cable information in FIG. 3 (step S140 in FIG. 3). However, the process of simulating the cable movable region based on the cable information is not limited to the example shown in FIG. 4 and modifications are possible.

In step S210, the simulation unit 13 sets the cable wiring planned positions (the starting end and the terminal end) 19b and the cable passage point 19c in the three-dimensional coordinates.

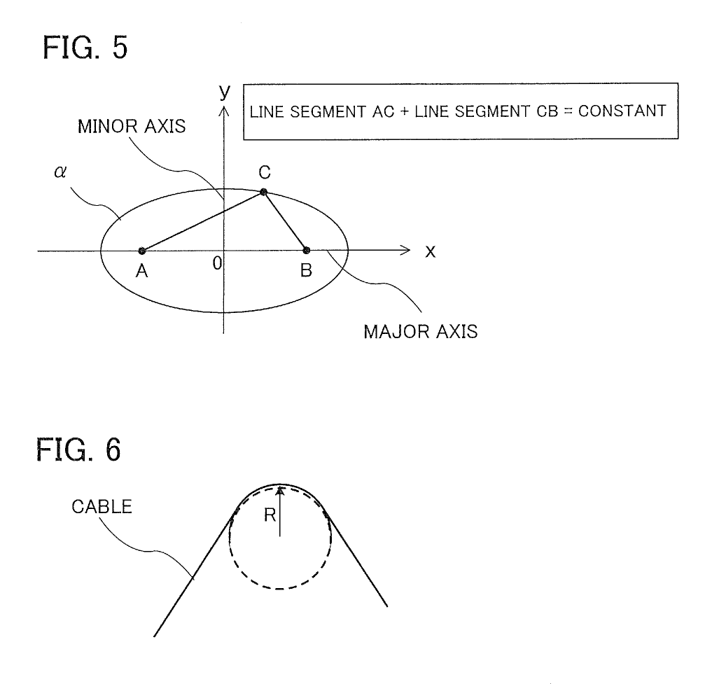

In the next step S220, the simulation unit 13 sets the starting end that was set in step S210 as a focal point A of an ellipse and sets a passage point next to the starting end as a focal point B of the ellipse as shown in FIG. 5.

In the next step S230, the simulation unit 13 generates an ellipse a having the focal point A and the focal point B set in step S220 and having a major axis equal to the length of the cable (=“cable length 19a”−(“length of used cable”+“minimum distance of remaining path”)) that can be used as shown in FIG. 5. Here, the reason why the ellipse a is generated here is that the focal point A and the focal point B of the ellipse and a point C on the periphery of the ellipse have a characteristic expressed as “line segment AC”+“line segment BC”=constant.

In step S240, the simulation unit 13 generates an ellipsoid β by rotating the ellipse a generated in step S230 around the major axis as a central axis. The ellipsoid β represents the cable movable region taking only the cable length into consideration. However, the cable cannot be bent at an acute angle and has the permissible bending radius R as a usable minimum bending radius as shown in FIG. 6. Therefore, in step S250, the simulation unit 13 extracts only a region in the ellipsoid β generated in step S240 where a bending radius of the cable is larger than the permissible bending radius R.

In the next step S260, the simulation unit 13 moves the focal point A and the focal point B to the next passage points. Specifically, the simulation unit 13 sets the focal point B in a previous process as the focal point A in a process next to the previous process, and sets a passage point next to the passage point in the previous process as the focal point B in the process next to the previous process.

In the next step S270, the simulation unit 13 judges whether or not the focal point A has reached the terminal end, and advances the process to step S280 if it has reached (the judgment results in YES), or returns the process to step S230 if it has not reached (the judgment results in NO).

In the next step S280, the simulation unit 13 sets the extracted region as the cable movable region and provides the image generation unit 14 with cable movable region information.

The image generation unit 14 generates the cable movable region image (two-dimensional image), as the AR image indicating the cable movable region in the real space, based on the cable movable region (three-dimensional CG) calculated by the simulation unit 13 and the position and posture of the user determined by the user position posture estimation unit 12, and makes the image display unit 15 display the cable movable region image (two-dimensional image).

### (1-3) Effect

As described above, with the cable movable region display device 10 or the cable movable region display method according to the first embodiment, the cable movable region is simulated, the AR image is generated based on the simulated cable movable region and the position and posture of the user, and the AR image of the cable movable region is displayed so as to be superimposed on the real space or so as to be superimposed on a real space image. Therefore, the cable movable region according to the characteristics of the cable can be displayed in an intuitive and easily understandable manner for the worker.

### (2) Second Embodiment

In the cable movable region display device 10 according to the above-described first embodiment, the simulation unit 13 calculates the cable movable region from the cable information (the cable length 19a and the cable permissible bending radius 19d) and the wiring path information (the starting end and the terminal end representing the wiring planned positions 19b, and the passage point 19c), and the image generation unit 14 generates the AR image based on the cable movable region calculated by the simulation unit 13 and makes the image display unit 15 display an image of the three-dimensional CG of the cable movable region from the starting end to the terminal end, or makes a projector as the image display unit 15 project the AR image of the cable movable region onto the real space.

In contrast to this, in a cable movable region display device 20 according to a second embodiment of the present invention, a hand position detection unit 21 detects the position of a hand of the worker (user) in the middle of the wiring work, and the image generation unit 14 executes a process of displaying the cable movable region from a position of the hand to the terminal end on the image display unit 15 as an image of the three-dimensional CG, or a process of making a projector as the image display unit 15 display the cable movable region from a position of the hand to the terminal end on the real space as the AR image.

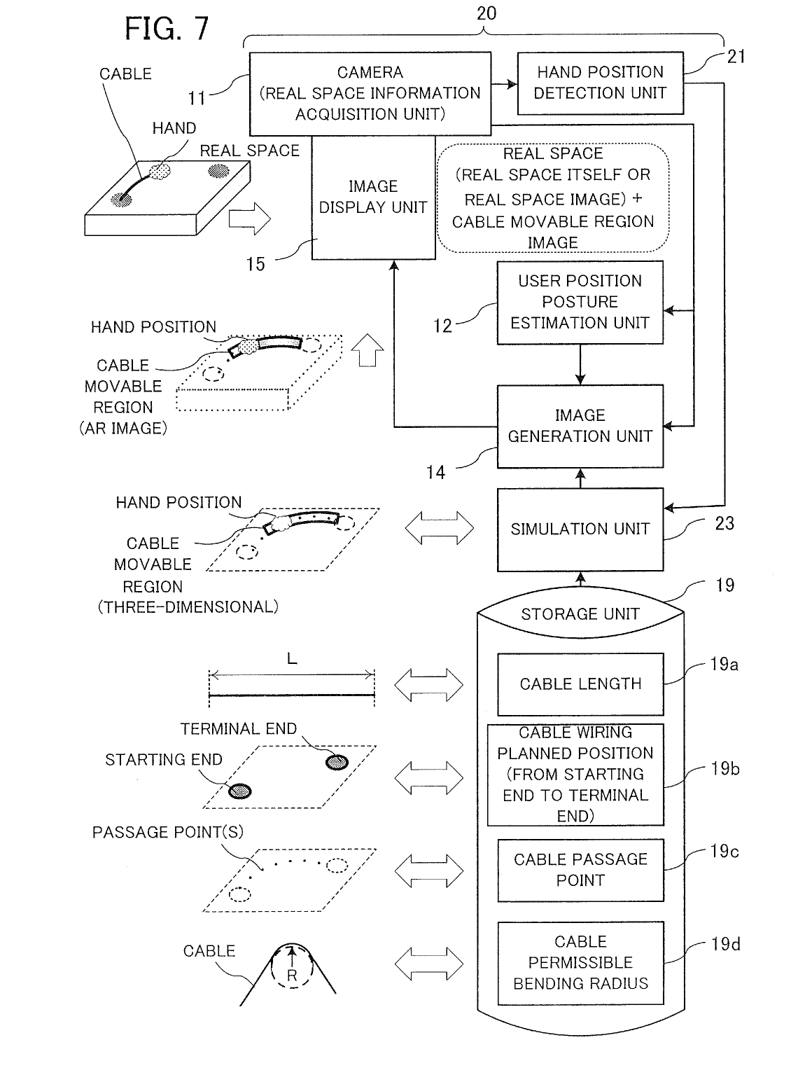

FIG. 7 is a diagram showing a configuration and functions of the cable movable region display device 20 according to the second embodiment. In FIG. 7, components identical or corresponding to components shown in FIG. 1 (first embodiment) are assigned the same reference characters as those in FIG. 1. The cable movable region display device 20 according to the second embodiment differs from the cable movable region display device 10 according to the first embodiment in including the hand position detection unit 21 for detecting a position of a hand of the worker based on the real space information acquired by the real space information acquisition unit 11, and in the processing performed by a simulation unit 23. Except for these respects, the cable movable region display device 20 and the cable movable region display method according to the second embodiment are the same as the cable movable region display device 10 and the cable movable region display method according to the first embodiment.

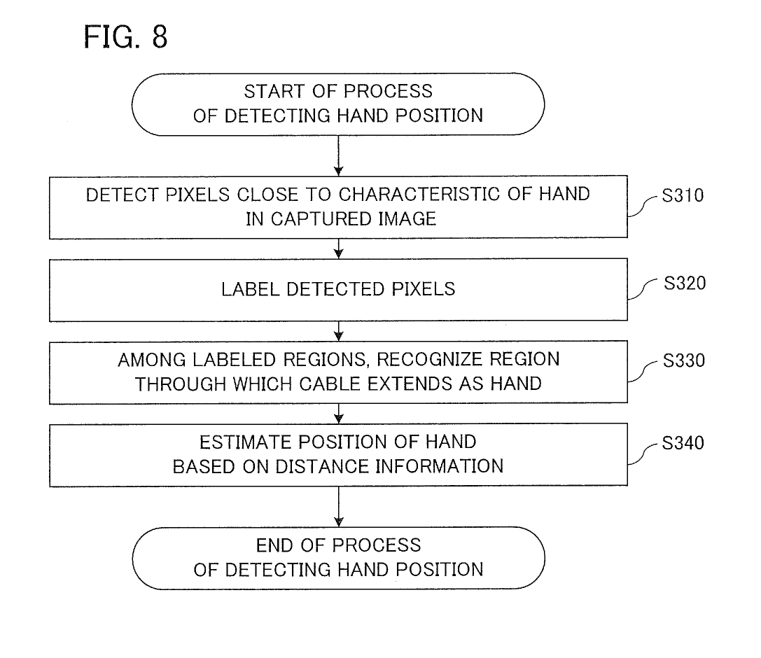

FIG. 8 is a flowchart showing an example of a process performed by the hand position detection unit 21 in the cable movable region display device 20 according to the second embodiment. However, a process of detecting a position of the hand is not limited to the method shown in FIG. 8 and a different process can be adopted. In a case where the real space information acquisition unit 11 includes a camera, the process of detecting a position of the hand shown in FIG. 8 is executed each time the camera captures an image (e.g., at constant time intervals). In a case where the real space information acquisition unit 11 includes a depth sensor, the process of detecting a position of the hand shown in FIG. 8 is executed each time the distance information regarding the distance to the subject is updated (e.g., at constant time intervals). Incidentally, FIG. 8 describes a case where the real space information acquisition unit 11 includes a camera and a depth sensor.

In step S310 of FIG. 8, the hand position detection unit 21 detects pixels having a color close to a hand color (color predetermined based on characteristics of a hand) in a camera image acquired by the real space information acquisition unit 11. Alternatively, the hand position detection unit 21 may detect pixels close to the temperature of the hand in a thermal image instead of detecting the pixels having a color close to the hand color. The hand position detection unit 21 may also be configured to use both of the pixels having a color close to the hand color and the pixels close to the temperature of the hand for the detection of the hand position. In the next step S320, the hand position detection unit 21 labels the image detected in step S310. In the next step S330, among regions labeled in step S320, the hand position detection unit 21 recognizes a region through which the cable (cord-like object) extends as the hand. In the next step S340, the hand position detection unit 21 calculates (estimates) the position of the hand recognized in step S330 based on the distance information acquired by the depth sensor of the real space information acquisition unit 11.

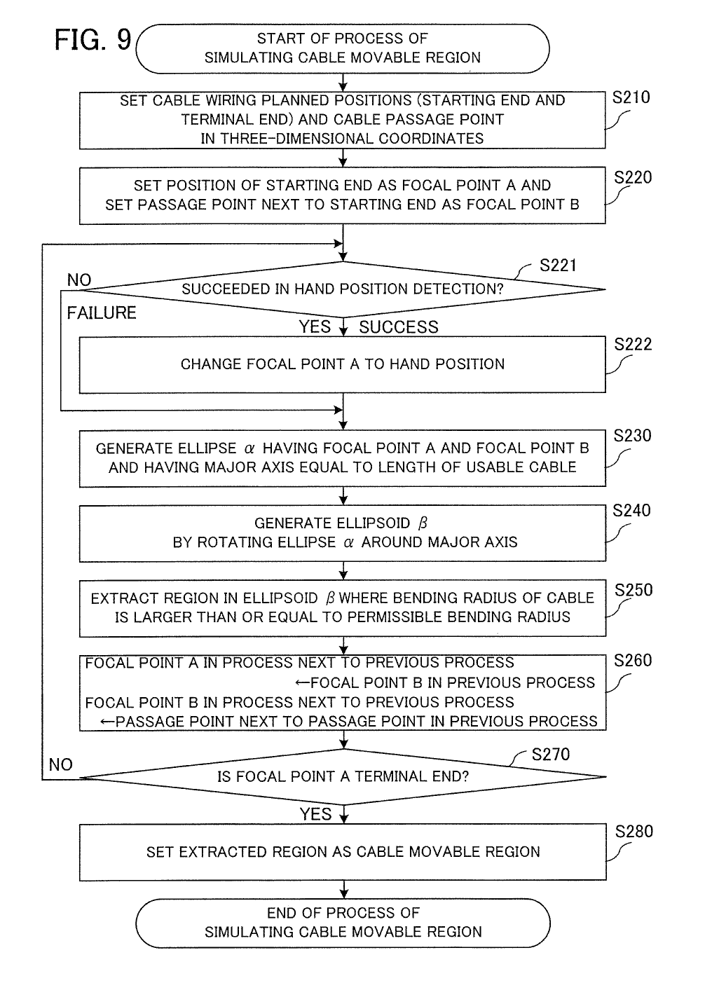

FIG. 9 is a flowchart showing an example of a process of simulating the cable movable region in the cable movable region display device 20 according to the second embodiment. In FIG. 9, process steps identical or corresponding to process steps shown in FIG. 4 (first embodiment) is assigned the same step number as those in FIG. 4. The simulation process shown in FIG. 9 differs from the simulation process shown in FIG. 4 (first embodiment) in including steps S221 and S222.

In step S221, the hand position detection unit 21 detects the position of the hand by performing the process of detecting a position of the hand shown in FIG. 8. When the hand position detection succeeded (YES in step S221), the simulation unit 23 changes the focal point A of the ellipse to the position of the hand in step S222 and performs the processing of step S230. When the hand position detection failed (NO in step S221), the simulation unit 23 performs the processing of step S230. Except for these respects, the simulation process of FIG. 9 is the same as the simulation process of FIG. 4 (first embodiment).

As described above, with the cable movable region display device 20 or the cable movable region display method according to the second embodiment, the cable movable region is simulated, the AR image is generated based on the simulated cable movable region and the position and posture of the user, and the AR image of the cable movable region is displayed so as to be superimposed on the real space. Thus, in the second embodiment, the cable movable region according to the characteristics of the cable can be displayed in an intuitive and easily understandable manner for the worker. Further, even when the worker is in the middle of work, the cable movable region can be displayed in real time, and thus display more appropriately corresponding to the current situation becomes possible and the display can be made in an intuitive and easily understandable manner for the worker.

### (3) Third Embodiment

In the above second embodiment, the description has been given of the cable movable region display device 20 and the cable movable region display method in which the cable movable region is updated in real time even when the worker is in the middle of the cable wiring work. However, there can be a case where an obstacle hindering the cable wiring (installation) exists in the cable movable region representing the permissible range of the wiring path of the cable. Further, when the work is carried out while the cable movable region is updated (changed), there can be a case where an obstacle not anticipated at the beginning exists in the updated cable movable region. Therefore, in a cable movable region display device 30 and a cable movable region display method according to a third embodiment of the present invention, a simulation unit 33 recognizes a part of a three-dimensional shape in the cable movable region as an obstacle region where an obstacle exists, and executes a process of excluding the obstacle region from the cable movable region.

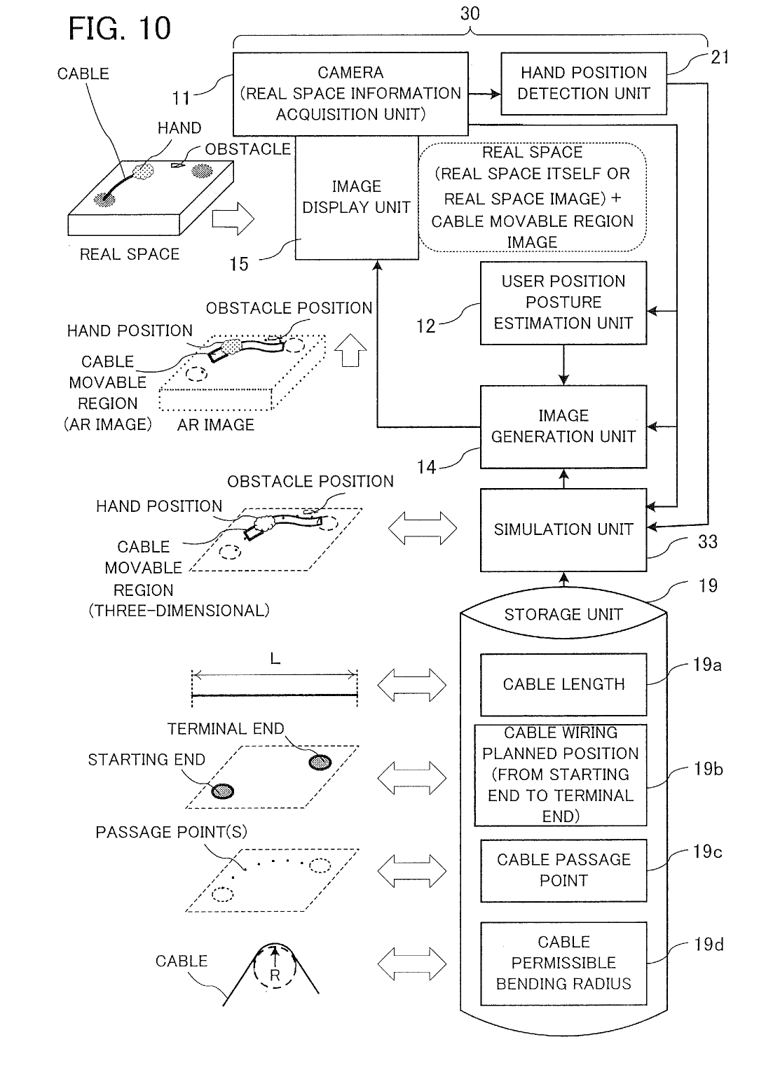

FIG. 10 is a diagram showing a configuration and functions of the cable movable region display device 30 according to the third embodiment. In FIG. 10, components identical or corresponding to components shown in FIG. 7 (second embodiment) are assigned the same reference characters as those in FIG. 7. The cable movable region display device 30 according to the third embodiment differs from the cable movable region display device 20 according to the second embodiment in that the simulation unit 33 acquires the real space information from the real space information acquisition unit 11 and detects a part of a three-dimensional shape in the cable movable region as the obstacle region where an obstacle exists, and in that the simulation unit 33 generates a new cable movable region by removing the obstacle region from the cable movable region. Except for these respects, the cable movable region display device 30 and the cable movable region display method according to the third embodiment are the same as the cable movable region display device 20 and the cable movable region display method according to the second embodiment.

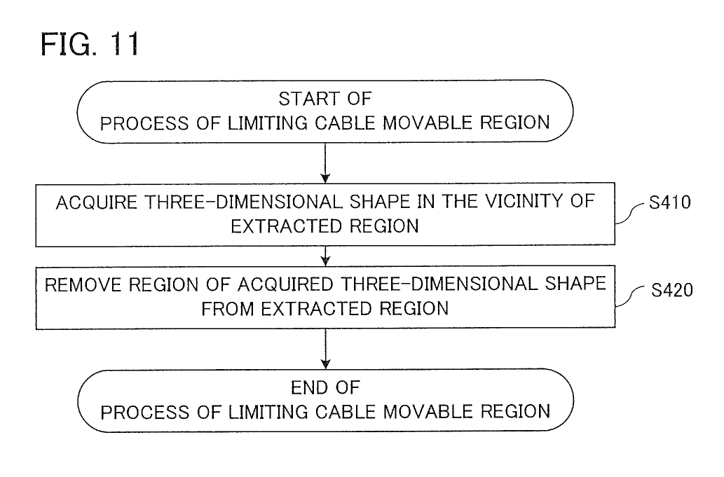

FIG. 11 is a flowchart showing an example of a process of limiting the cable movable region in the cable movable region display device 30 according to the third embodiment. The process of limiting the cable movable region in the third embodiment is a process executed between steps S270 and S280 in FIG. 4 or FIG. 9. In step S410, the simulation unit 33 acquires the three-dimensional shape in the vicinity of the cable movable region from a distance image acquired by the real space information acquisition unit 11. In the next step S420, the simulation unit 33 generates a limited cable movable region by removing a common part between the region extracted in step S250 and a region of the three-dimensional shape acquired in step S410 from the region extracted in step S250. Incidentally, the process of detecting a position of the hand can be a process different from the process shown in FIG. 11.

As described above, the cable movable region display device 30 and the cable movable region display method according to the third embodiment are characterized in that data is supplied from the real space information acquisition unit 11 to the simulation unit 13. According to this feature, the cable movable region can be limited when an obstacle exists in the wiring path, by which a more appropriate display depending on the situation becomes possible and the display can be made in an intuitive and easily understandable manner for the worker.

### (4) Fourth Embodiment

The image generation unit 14 in the cable movable region display devices 10, 20 and 30 according to the above first to third embodiments makes the image display unit 15 (display device 57) display the two-dimensional image obtained by the conversion from the three-dimensional CG of the cable movable region, or makes a projector as the image display unit 15 project the AR image of the cable movable region onto the real space. However, depending on the characteristics (e.g., type, number of pixels, resolution, screen size, etc.) of the display device, in some cases, the two-dimensional image generated by the projection conversion of the three-dimensional CG is incapable of displaying information such as depth information in a sufficiently understandable manner. Therefore, an image generation unit 44 of a cable movable region display device 40 according to a fourth embodiment has a function of adding color information (display with multiple colors different from each other, or display with a difference in density in multiple steps) to the two-dimensional image according to thickness information regarding the three-dimensional CG of the cable movable region.

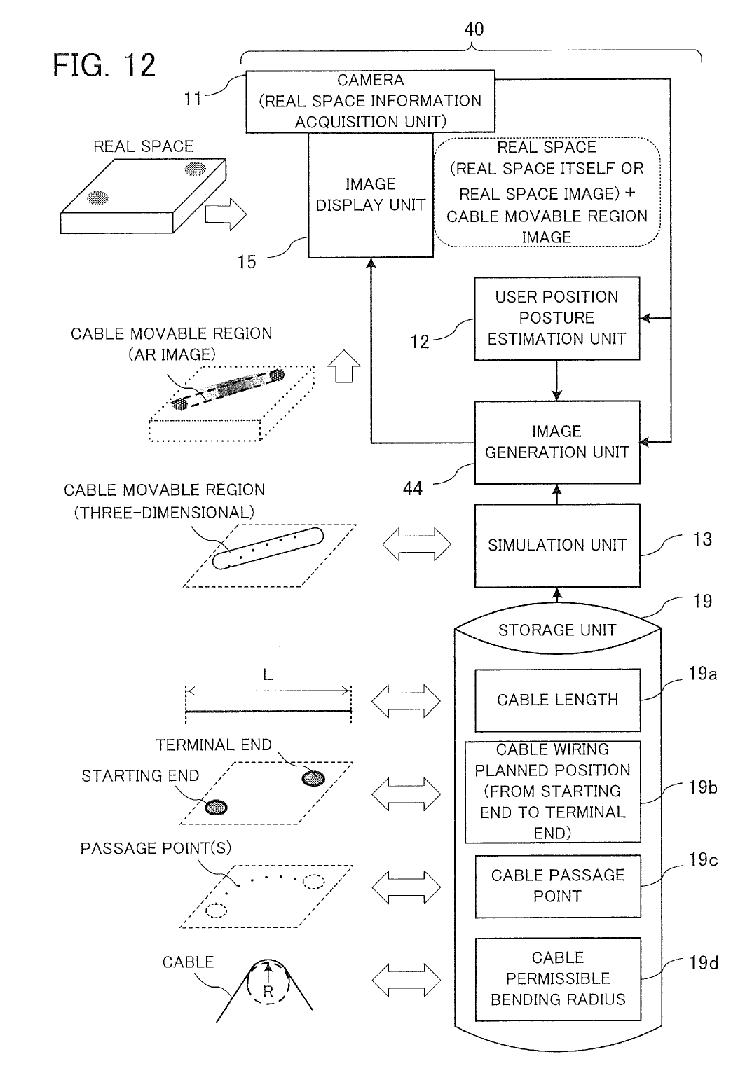

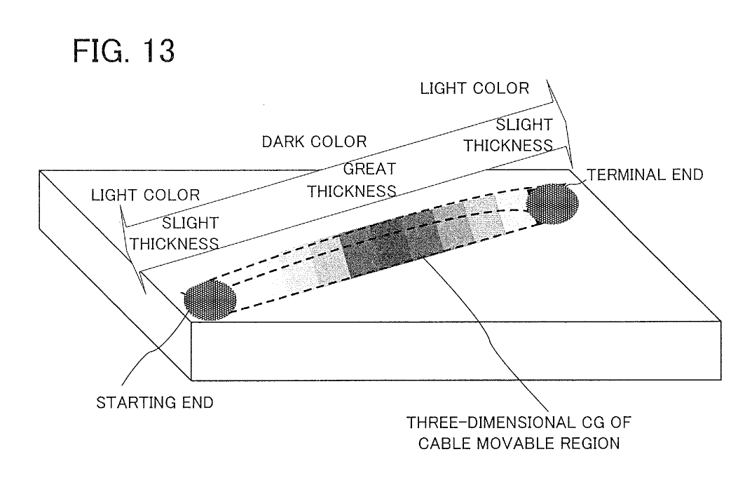

FIG. 12 is a diagram showing a configuration and functions of the cable movable region display device 40 according to the fourth embodiment. In FIG. 12, components identical or corresponding to components shown in FIG. 1 (first embodiment) are assigned the same reference characters as those in FIG. 1. The cable movable region display device 40 according to the fourth embodiment differs from the cable movable region display device 10 according to the first embodiment in that the image generation unit 44 has the function of adding the color information (display with multiple colors different from each other, or display with a difference in density in multiple steps) to the two-dimensional image according to the thickness information regarding the three-dimensional CG of the cable movable region as shown in FIG. 13. Except for these respects, the cable movable region display device 40 and the cable movable region display method according to the fourth embodiment are the same as the cable movable region display device 10 and the cable movable region display method according to the first embodiment.

FIG. 13 is a diagram showing a display example of the cable movable region displayed on the image display unit 15 by the image generation unit 44 of the cable movable region display device 40 according to the fourth embodiment. For example, the image generation unit 44 can employ a display method for displaying a part having the greatest thickness in the three-dimensional CG in a red color and gradually changing the color from red to blue with the decrease in the thickness in the three-dimensional CG (display method for emphasizing the thickness by using multiple colors). Further, the image generation unit 44 can employ a display method for displaying a part having the greatest thickness in the three-dimensional CG in a dark color and gradually changing the color from the dark color to a light color with the decrease in the thickness in the three-dimensional CG (display method for emphasizing the thickness by using gradation). In cases where the image display unit 15 is a projector, the image generation unit 44 can employ a display method for displaying a part having the greatest thickness in the AR image projected onto the real space in a dark color and gradually changing the color from the dark color to a light color with the decrease in the thickness (display method for emphasizing the thickness by using gradation).

As described above, with the cable movable region display device 40 and the movable range display method according to the fourth embodiment, when the three-dimensional CG of the cable movable region is converted into a two-dimensional image and displayed on the image display unit 15 (display device 57), the thickness information on the cable movable region is added by using multiple different colors or gradation of a color. Employing such display enables the worker to recognize not only the two-dimensional image converted from the three-dimensional CG but also color information or gradation information in regard to the thickness. Thus, with the cable movable region display device 40 and the movable range display method according to the fourth embodiment, intuitive and easily understandable display of the cable movable region can be provided to the worker.

Incidentally, the process in the image generation unit 44 in the fourth embodiment is applicable also to each of the second and third embodiments.

### DESCRIPTION OF REFERENCE CHARACTERS

10, 20, 30, 40: cable movable region display device (information display device), 11: real space information acquisition unit (camera, sensor), 12: user position posture estimation unit, 13, 23, 33: simulation unit, 14, 44: image generation unit, 15: image display unit, 19: storage unit, 19a: cable length, 19b: cable wiring planned positions (starting end and terminal end), 19c: cable passage point, 19d: cable permissible bending radius, 21: hand position detection unit, 51: CPU, 52: GPU, 53: main memory, 54: storage, 55: camera, 56: sensor, 57: display device, 58: bus.

1-11. (canceled)

12. A cable movable region display method for making an image display display a cable movable region representing a permissible range of a wiring path of a cable while making the image display superimpose the cable movable region on a real space, the cable movable region display method comprising:
acquiring real space information regarding the real space;
determining a position and posture of a user based on the real space information;
acquiring wiring path information indicating a starting end, a passage point and a terminal end of the wiring path and cable information indicating a permissible bending radius of the cable and a length of the cable and calculating the cable movable region based on the wiring path information and the cable information;
generating a cable movable region image of virtual reality indicating the cable movable region in the real space based on the calculated cable movable region and the determined position and posture; and
making the image display display the cable movable region image of virtual reality.

13. (canceled)

14. A cable movable region display device for displaying a cable movable region representing a permissible range of a wiring path of a cable while superimposing the cable movable region on a real space, the cable movable region display device comprising:
a processor to execute a program; and
a memory to store the program which, when executed by the processor, performs a real space information acquisition process of acquiring real space information regarding the real space;
a user position posture estimation process of determining a position and posture of a user based on the real space information;
a simulation process of acquiring wiring path information indicating a starting end, a passage point and a terminal end of the wiring path and cable information indicating a permissible bending radius of the cable and a length of the cable and calculating the cable movable region based on the wiring path information and the cable information;
an image generation process of generating a cable movable region image of virtual reality indicating the cable movable region in the real space based on the cable movable region calculated in the simulation process and the position and posture determined in the user position posture estimation process; and
a display process of making an image display display the cable movable region image of virtual reality.

15. The cable movable region display device according to claim 14,
wherein the memory to store the program which, when executed by the processor, further performs a hand position detection process of detecting a position of a hand of the user based on the real space information,
wherein the simulation process includes a process of calculating the cable movable region on a supposition that the position of the hand is the passage included in the wiring path information.

16. The cable movable region display device according to claim 14, wherein the simulation process includes a process of detecting a part of a three-dimensional shape existing in the cable movable region as an obstacle region where an obstacle exists based on the real space information, and a process of outputting a region obtained by removing the obstacle region from the cable movable region, as a new cable movable region.

17. The cable movable region display device according to claim 16, wherein the image generation process includes a process of adding additional information according to a three-dimensional shape of the cable movable region to the cable movable region image of virtual reality.

18. The cable movable region display device according to claim 16, wherein the additional information includes at least one of a difference in color and a difference in density.

19. The cable movable region display device according to claim 14, wherein the image display includes a see-through display that allows light to pass through and displays the cable movable region image of virtual reality.

20. The cable movable region display device according to claim 14, wherein the image display includes a projector that projects the cable movable region image of virtual reality onto the real space.

21. The cable movable region display device according to claim 14, wherein the image generation process includes a process of displaying the real space on the image display based on image information acquired in the real space information acquisition process and also displays the cable movable region of virtual reality on the image display.

22. The cable movable region display device according to claim 14, further comprising a storage to store the wiring path information and the cable information,
wherein the simulation process includes a process of calculating the cable movable region based on the wiring path information and the cable information stored in the storage.

23. The cable movable region display device according to claim 14, wherein the real space information acquisition process is performed by at least one of a camera that acquires image data as the real space information and a sensor that acquires a detection value as the real space information.

24. The cable movable region display device according to claim 14, wherein the image display and at least one of the camera and the sensor have a structure of a head-mounted type to be mounted on a head of the user.
